(19) United States
(12) Patent Application Publication
(10) Pub. No.: US 2005/0142255 A1
(43) Pub. Date: Jun. 30, 2005

(54) Method of heating a food

(76) Inventors: Nicole L. Blankenbeckler, Richmond, VA (US); Cheng-Hang Chi, Midlothian, VA (US); Paul Roger Kust, (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/749,676

(22) Filed: Dec. 31, 2003

(51) Int. Cl. A23L 3/00

(52) U.S. Cl. 426/243

(57) ABSTRACT

The present invention is directed to a method of heating a food, comprising the step of imparting microwave energy to a food wherein a portion of the microwave energy is converted to heat by use of a coating derived from an ink comprising natural polymer binder, substantially non-aggregated particulate nonmetallic microwave susceptor material, an aqueous solvent for the natural polymer binder, and, optionally, a chemical dispersing aid. The food is heated, and preferably browned, without the occurrence of electrical arcs that would burn the food or damage the oven.

### BACKGROUND OF THE INVENTION

1. Field of the Invention

The present invention is directed to a method of heating a food, comprising the step of imparting microwave energy to a food wherein a portion of the microwave energy is converted to heat by use of a coating derived from an ink comprising natural polymer binder, substantially non-aggregated particulate nonmetallic microwave susceptor material, an aqueous solvent for the natural polymer binder, and, optionally, a chemical dispersing aid.

2. Description of Related Art

The use of microwave energy to heat foods is well known, however, a major disadvantage is the inability to quickly and sufficiently brown the surface of the foods being heated. In addition, efforts to create a truly satisfying and reliable cooking article containing a susceptor ink have been hampered because such articles need a high concentration of microwave susceptor material to achieve the high temperature required for browning, and such high concentrations of susceptor material tend to cause electrical arcs in the microwave, burning the food and damaging the microwave.

U.S. Pat. No. 4,914,266 to Parks discloses a microwave susceptor ink comprising a conductive carbon material, a resin soluble in alcohol but insoluble in water, such as nitrocellulose, and an alcohol solvent. Such susceptor inks incorporate organic solvents, which are not desirable because they can require special handling due to their generally flammable nature and can have potential health effects.

European Patent EP 365 729 discloses a printed coating comprising a microwave susceptor composed of a fluid organic and resinous printing ink vehicle or film former that serves as a base or matrix to hold the ink together and to the underlying substrate. The vehicle can comprise any suitable ink vehicle such as an acrylic or maleic resin, e.g. maleic rosin ester, polyvinyl acetate, protein, or soluble shellac. As shown in the examples of this patent, the ink vehicle is further diluted with water to create a finished ink for printing having 16% solids in water. The ink further includes electrically conductive carbon particles and non-conductive attenuator particles, with the electrically conductive carbon particles calculated to be present in the finished (printed) ink composition in the range of 2.1 to 6.7 percent. The non-conductive attenuator particles are used to modulate the carbon particles and reduce their heating effect, and all of the particles are dispersed in the fluid ink vehicle by means of a ball mill, rod mill, or roller mill until a uniform dispersion is obtained.

U.S. Pat. No. 4,970,358 discloses uncontrolled or runaway heating occurs when carbon is used alone as the microwave interactive component and therefore a thermocompensating attenuator is required to make useful microwave susceptor compositions.

U.S. Patent App. 2003/0136302 discloses flexographic black ink compositions comprising soy protein and carbon black. Such inks are used as preprint inks for corrugated paper packaging materials, withstanding the heat and pressure of corrugation along with displaying acceptable printing properties.

U.S. Pat. No. 4,892,782 discloses the use of naturally occurring microwave susceptive ingredients, including poly- and mono-saccharides coated on and/or imbibed into drapable, fibrous dielectric substrates.

Therefore, what is needed is a way to reliably heat and brown a food without arcing, comprising the step of imparting microwave energy to a food wherein a portion of the microwave energy is converted to heat by use of a coating derived from an ink that is made from health-friendly components.

### SUMMARY OF THE INVENTION

This invention relates to a method of heating a food, comprising the step of imparting microwave energy to a food wherein a portion of the microwave energy is converted to heat by use of a coating derived from an ink, comprising 5 to 20 parts by weight natural polymer binder, 7 to 20 parts by weight of a substantially non-aggregated particulate nonmetallic microwave susceptor material, 50 to 88 parts by weight of an aqueous solvent for the natural polymer binder, and, optionally, up to 10 parts by weight of a chemical dispersing aid for the microwave susceptor material, wherein the binder, microwave susceptor material, solvent and chemical dispersing aid total 100 parts by weight.

This invention further relates to a process for making a liquid coating composition for forming a microwaveable coating, comprising;
a) combining, to form a mixture, particulate microwave susceptor material, water, and optionally, a chemical dispersing aid for the microwave susceptor material,
b) milling the mixture to separate any aggregated particles of microwave susceptor material and to disperse the microwave susceptor material in the water, to form a mixture of substantially non-aggregated microwave susceptor material in water, and
c) contacting the mixture of substantially non-aggregated microwave susceptor material in water with a natural polymer binder to form a liquid suitable for coating an article for the purpose of converting a portion of microwave energy to heat.

### DETAILS OF THE INVENTION

This invention relates to a method of heating a food using microwave energy to heat a coating of a microwave susceptor ink on a substrate, article, or packaging. By coating is meant both a traditional polymer coating and, also, one or more printed layers of ink. The ink comprises 5 to 20 parts by weight natural polymer binder, 7 to 20 parts by weight of a substantially non-aggregated particulate nonmetallic microwave susceptor material, 50 to 88 parts by weight of an aqueous solvent for the natural polymer binder, and, optionally, up to 10 parts by weight of a chemical dispersing aid for the microwave susceptor material, wherein the binder, microwave susceptor material, solvent and chemical dispersing aid total 100 parts by weight.

The natural polymer binder is a resin capable of forming a film and should adhere to the substrate when dried. 5 to 20 parts by weight of the natural polymer binder can be used in the ink, preferably 9 to 13 parts by weight. More than 20 parts tends to have viscosity and solubility limitations in water, while less than 5 parts tends to not have enough binding capability to be effective.

The natural polymer binder used in this invention should be health-friendly and preferably should have FDA or equivalent governmental clearance for contact with food. Further, such binders should be soluble in aqueous systems. Natural binders that fit this description include soy protein, vegetable protein, or derivatives thereof; corn starch, polysaccharides or derivatives thereof; and binders derived from cellulosic material. Preferred natural polymer binders are commercially available, water-soluble, can be used as a food additive, and are thermally stable up to about 200 degrees Centigrade or higher in air. The most preferred binder is soy protein or a derivative thereof.

The term “susceptor material” is employed in its normal definition in the microwave art, namely, a material which absorbs energy from microwaves and converts the energy in the form of heat. The susceptor material used in the present invention is a particulate material, and preferably the particulate material has a particle size ranging from 1 to 500 nanometers. Such particles tend to clump together or agglomerate to form aggregates, which, if not separated, create hot spots in the final coating. This is especially true when the printed coatings have in excess of 35 percent susceptor material, where such hot spots create electrical arcs that can burn the food and damage the microwave oven. Therefore, the susceptor material is treated during the manufacture of the ink, preferably by milling in water, to reduce the size and number of clumps or aggregates. Therefore, by substantially non-aggregated it is meant the particulate susceptor material has been mechanically or otherwise treated to de-clump or de-agglomerate a majority of the aggregates formed by the susceptor material.

The susceptor material is present in the ink in an amount of 7 to 20 parts by weight of the final ink composition. Preferably the material is present in an amount of 9 to 13 parts by weight. Compositions having less than 7 parts by weight generally do not perform well because the thickness required to make a useful coating tends to be excessively thick and difficult to manufacture. Also, the amount of interactive material present in the final coating should be above the percolation threshold. That is, the microwave interactive material should be present in an amount necessary to form a continuous or essentially continuous electrically interconnected network on the substrate. Compositions having more than 20 parts by weight tend to create dried coating compositions having too much particulate matter, which tends to flake off. They also tend to heat the food too quickly, burning the food in contact with the susceptor material before the rest of the food is completely cooked.

The susceptor is a non-metallic material. Metal flakes are difficult to keep dispersed in inks because they tend to settle. The non-metallic susceptor material used in this invention preferably should have FDA or equivalent governmental clearance for contact with food. Such materials can include carbon materials, carbon black or graphite. Preferably carbon black with low residual polynuclear aromatic material is used.

The ink is a water-based ink using an aqueous solvent. By aqueous it is meant that the water can contain minor amounts of other liquids such as acids and bases, however a predominant amount of the liquid is water. The aqueous solvent is present in an amount of from 50 to 88 parts by weight of the final ink. Inks having more or less than that amount of water tend to have viscosities that make them less desirable for use in printing or coating applications.

The ink can have, as an optional component, a chemical dispersing aid to help in the dispersing of the microwave susceptor particles in water. Such dispersing aids should be health-friendly and preferably should have FDA or equivalent governmental clearance for contact with food. If desired, the dispersing aid can be used in amounts up to 10 parts by weight of the ink without adversely affecting the printing of the coating or performance of the final microwave coating. Useful chemical dispersing aids include polyoxyethylene (20) glycerin monostearate, polyoxyethylene (20) sorbitan monolaurate (Polysorbate 20), polyoxyethylene (20) sorbitan monostearate (Polysorbate 60), and/or polyoxyethylene (20) sorbitan monooleate (Polysorbate 80).

The water-based inks of this invention have a fluid viscosity suitable for them to be printed onto substrates, and the viscosity is highly dependent on the printing process. For screen printing a viscosity of about 5,000 centipoise or greater is desired, while for gravure printing a viscosity of about 500 centipoise or less is desired. Alternatively, other health-friendly additives and/or pigments can be added as long as the final coating composition performs and is safe for food contact.

The ink can contain additives that maintain shelf-life or assist in the printing process. For example, since natural polymers are used a biocide may need to be added to prevent souring of the ink. The ink can also be tailored for the printing process that is to be used, for example, to make a screen printing ink a humectant can be added to decrease drying rate and improve screen life.

The water-based inks of this invention have a high solids content and preferably do not contain any additives used expressly to attenuate or reduce the heat generated by the carbon from the microwave radiation. If the ink is to be used in a gravure printing process, the solids content of the finished ink is greater than 20 percent and generally in the range of 22 to 26 percent or higher based on whether or not a surfactant is included with the microwave susceptor and the binder. If the ink is to be used in a screen printing process, the solids content of the finished ink is greater than 25 percent and generally in the range of 35 percent or higher, based on whether or not a surfactant and/or a humectant is included with the microwave susceptor and the binder resin.

These inks are preferably printed or coated onto a substrate in such quantity so as to create a cooking surface on that substrate that has in excess of 35 weight percent microwave susceptor particles that are both substantially non-aggregated and uniformly dispersed in the natural polymer binder. Such coatings are used to cook food, achieving very high temperatures when contacted with microwave energy without producing damaging arcs to the food or the microwave oven.

This invention further relates to a process for making a liquid coating composition for forming a microwaveable coating, comprising the steps of:
a) combining, to form a mixture, particulate microwave susceptor material, water, and optionally, a chemical dispersing aid for the microwave susceptor material,
b) milling the mixture to separate any aggregated particles of microwave susceptor material and to disperse the microwave susceptor material in the water, to form a mixture of substantially non-aggregated microwave susceptor material in water, and
c) contacting the mixture of substantially non-aggregated microwave susceptor material in water with a natural polymer binder to form a liquid suitable for coating an article for the purpose of converting a portion of microwave energy to heat.
   The microwave susceptor material is combined with the aqueous solvent, and optionally a chemical dispersing agent, by essentially any method as long as a liquid mixture results. The mixture is then milled in a mill to separate aggregated particles of microwave susceptor material in the mixture. The binder is preferably not added before or during the milling step because the binder tends to foam when milled, which is an inconvenience. If desired, a chemical defoaming aid can be added to the mixture to help reduce the amount of foaming caused by the binder and/or the milling process.

The milling can be accomplished by any of many conventional techniques that apply high energy to fluids in the form of very high shear or impact with solids. Examples of mills that can be used to apply high energy to fluids include but are not limited to liquid media mills, microfluidizers, rotor stator mixers and/or attritors. Only one pass through the mill is generally sufficient to separate the aggregated microwave susceptor particles, however, two passes are preferred. While more passes through the mill can be made, generally fewer than five passes are needed to make the ink of this invention.

Once the mixture of substantially non-aggregated microwave susceptor material is formed, it can be contacted with the natural polymer binder by any appropriate means, including additional milling, stirring, or high shear mixing, however, high energy mixing is not generally required.

The ink can then be coated or printed on a substrate, preferably one made from a high temperature material like aramid material, to make a microwavable article for heating food. A food can then be placed on the microwavable article and then the combination can be placed in a microwave oven wherein microwave energy is converted to heat by use of the coating derived from the ink, without the occurrence of electrical arcs that would burn the food or damage the oven.

### TEST METHODS

Susceptor Test

Microwave heating effectiveness of susceptor-applied substrates, or microwavable substrates, was measured by use of an oil/water competition test. This test gives a quantitative measure of heating power for different microwavable substrate by cooking oil in a glass beaker above a microwavable substrate in competition with a water-filled beaker without susceptor. The amount of temperature rise of the oil serves as an indicator of heating power of the microwavable substrate. In addition, the test conditions serve as a useful proxy for imperfect food contact or for overcooking excursions with food because of the harshness of the test—since there is some thermal lag within the glass and imperfect contact of microwavable substrate to glass because of beaker geometry (slightly concave bottom).

100 grams of Type 710 oil was placed in a 250 mL beaker. 400 mL of distilled water was placed in a 600 mL beaker. A 4.1 cm circle was cut from the test microwavable substrate material. The oil and water initial temperature was measured and recorded. Both beakers were placed in a Emerson 900 Watt, Model Number MW8987B microwave oven with the water beaker placed to one side and oil beaker sitting on the microwavable substrate (with the active side of the microwavable substrate facing towards the oil beaker bottom). The oil beaker should be centered on the microwavable substrate and centered in the microwave on the turntable. The microwave was then run on high heat for 1 minute and 3 seconds. The sample was monitored and if flames or arcing appeared the test was stopped. Once time has expired (or test stopped) the temperature of the oil (first) and then the water was measured and recorded. The microwavable substrate was examined for signs of arcing (jagged, burned out lines), which were noted if present. The difference between the oil start and finish temperature was calculated for the tests that were not stopped due to flames or arcing. The difference between the initial and final temperature of the oil gave an indication of how microwave interactive the microwavable substrate is and can be used to calculate heat generation. The oil had a specific heat of 1.52 kJ/(kg*K).

### EXAMPLE 1

This example illustrates a milled sample is more efficient in heating in a microwave than a non-milled sample.

Ink Preparation

Ink A of this invention was prepared in three steps. First the dispersion aid, water and defoamer were mixed together with a Cowles blade at 1000 rpm. The carbon black was added while under agitation and allowed to mix at 2000 rpm for 2 hours. The next step was to mill the carbon dispersion in a horizontal media mill. Milling was done with 0.8-1.0 mm zirconia media and ceramic agitator operating at a tip speed of 2400 feet per minute for a batch residence time of 62 minutes. In the final step, water was mixed into the milled dispersion at low speed. Ammonium hydroxide was added to raise the pH of the mixture above 10.0. Soy protein (Procote 2500) and ammonium hydroxide were added in aliquots of 10 g protein followed by 1.5 g ammonium hydroxide until the formula amount of protein was mixed in. The mixing speed was increased to a point that provided a stable mixing vortex without excessive air entrainment, and the mixture was mixed at this higher speed for 1 hour. Mixing speed was then reduced and the mixture pH was adjusted above 9.5 with ammonium hydroxide; glycerin, biocide (Proxel GXL), and remaining water were added with mixing, and the mixture was mixed for an additional 15 minutes. The finished ink had a solids content of approximately 25.5 percent.

Comparison Ink B was prepared in two steps. First the surfactant, water and defoamer were mixed together with a Cowles blade at 1800 rpm. The carbon black was added while under agitation and allowed to mix for 30 minutes. The next step was to add the soy protein to the black dispersion using an air mixer (low shear) and then adjust the pH using ammonium hydroxide. This was allowed to mix for one hour. Then the glycerin was added. The finished ink had a solids content of approximately 25.5 percent.

| Component | Ink A | Ink B |
|---|---|---|
| Carbon black | 11.0% | 11.0% |
| (Cabot Black | | |
| pearls 4350) | | |
| Dispersing aid | 4.4% | 4.4% |
| (Tween 80) | | |
| Soy protein (Procote) | 10.1% | 10.1% |
| NH3 | 1.8% | 1.0% |
| Glycerin | 1.0% | 1.0% |
| Water | Remainder | Remainder |
| Defoamer (Sag | 0.02% | 0.02% |
| 770) | | |
| Biocide (Proxel | 0.20% | 0% |
| GXL) | | |

Microwavable Substrate Preparation:

Microwavable substrates were prepared using a special coating method described below. The substrates used were sheets of 30 cm length by 30 cm width, 0.1 mm thickness aramid paper (Type 4N710 from DuPont). A uniform base coat of 0.127 mm (5 mils) wet film thickness was first applied to the substrates using a wet film applicator available from Paul N. Gardner Company. The composition of the base coat was 14.7 wt. % modified soy protein (Pro-cote 200 from Bunge), 1.1 wt. % glycerin, 0.74 wt. % ammonia, and 83.46 wt. % water. The coated sheets were dried in a 100 degree C. oven for 15 minutes. A second coating of microwave interactive inks A and B were then applied using the same method across the base coat (applied at a 90° angle). The coated sheet was dried in a 100 degree C. oven for 20 minutes and then allowed to cool.

Microwavable Substrate Testing:

Microwavable substrate testing was run four times with samples of the microwavable substrates containing milled Ink A of this invention and no arcing occurred. Eight test runs were required with samples of the microwavable substrates containing unmilled Ink B to obtain four good results without arcing. In other words, half of the samples of microwavable substrates that were made with Ink B caused arcing in the test and were not used in further calculations. Oil on the coated microwavable substrates containing the milled Ink A heated up an average of 4.8° C. more than that on the microwavable substrates containing the unmilled Ink B. Statistically this was a significant difference at a 95% confidence level. This indicates that an additional 730 Joules of heat was created by the milled sample from Ink A.

### EXAMPLE 2

Microwave Susceptor Coating Composition Preparation:

A microwave susceptor coating composition was prepared. The ink was prepared in three steps. First the dispersion aid, water and defoamer were mixed together with a Cowles blade at 1000 rpm. The carbon black was added while under agitation and allowed to mix at 2000 rpm for 2 hours. The next step was to mill the carbon dispersion in a horizontal media mill. Milling was done with 0.8-1.0 mm zirconia media and ceramic agitator operating at a tip speed of 2400 feet per minute for a batch residence time of 62 minutes. In the final step, water was mixed into the milled dispersion at low speed. Ammonium hydroxide was added to raise the pH of the mixture above 10.0. Soy protein (Procote 2500) and ammonium hydroxide were added in aliquots of 10 g protein followed by 1.5 g ammonium hydroxide until the formula amount of protein was mixed in. The mixing speed was increased to a point that provided a stable mixing vortex without excessive air entrainment, and the mixture was mixed at this higher speed for 1 hour. Mixing speed was then reduced and the mixture pH was adjusted above 9.5 with ammonium hydroxide; glycerin, biocide (Proxel GXL), and remaining water were added with mixing, and the mixture was mixed for an additional 15 minutes. Solids content of the final ink was approximately 26 percent.

| Component | Ink A |
|---|---|
| Carbon black | 11.0 |
| (Cabot Black | |
| Pearls 4350) | |
| Dispersing aid | 4.4 |
| (Tween 80) | |
| Soy protein (Procote | 10.1 |
| 2500) | |
| NH3 | 1.8 |
| Glycerin | 1.0 |
| Water | Remainder |
| Biocide (Proxel | 0.2 |
| GXL) | |
| Defoamer (SAG | 0.02 |
| 770) | |

Microwavable Substrate Preparation:

A microwavable substrate was prepared. The substrate used was a sheet of 30 cm length by 30 cm width, 0.1 mm thickness aramid paper (Type 4N710 from DuPont). A uniform base coat of 0.127 mm (5 mils) wet film thickness was first applied to the substrate using a wet film applicator available from Paul N. Gardner Company. The composition of the base coat was 14.7% modified soy protein (Pro-cote 200 from Bunge), 1.1% glycerin, 0.74% ammonia, and 83.46% water. The coated sheet was dried in a 100 degree C. oven for 15 minutes. A second coating of microwave susceptor ink (prepared and of the composition listed in part A) was applied to create a half-circle ink deposition of 15.2 cm diameter with a gradual increase of coated ink towards the center of the circle. The applicator used was a 7.6 cm wide wet film applicator with a gap of 0.051 mm or 2 mils (Model AP-SS324 from Paul N. Gardner Company). Two shims were placed at one end (End A) of the applicator to increase the gap to 0.145 mm (5.7 mils). This created a wet film gap with a gradient from 0.145 mm at (End A) to 0.051 mm at the other end (End B). The half-circle ink coating was created by holding End A of the applicator stationary while rotating End B by 180°. The coated sheet was dried in a 100 degree C. oven for 20 minutes and then allowed to cool.

Microwave Cooking Test:

The half circle of microwavable substrate was cut out, perforated with pinholes and placed on an inverted porous paper plate in a 900 W microwave oven. A frozen pizza (15.2 cm diameter Tombstone Pizza for One with Extra Cheese) was placed on the perforated half circle with the susceptor ink side in contact with the pizza and allowed to cook for 4 minutes at 100% power. The result showed that the crust was evenly browned on the side with the susceptor ink and not browned at all on the side without the susceptor ink.

1. A method of heating a food, comprising the step of imparting microwave energy to a food wherein a portion of the microwave energy is converted to heat by use of a coating derived from an ink, comprising:
a) 5 to 20 parts by weight natural polymer binder,
b) 7 to 20 parts by weight of a substantially non-aggregated particulate nonmetallic microwave susceptor material,
c) 50 to 88 parts by weight of an aqueous solvent for the natural polymer binder, and
d) optionally, up to 10 parts by weight of a chemical dispersing aid for the microwave susceptor material,
wherein the binder, microwave susceptor material, solvent and chemical dispersing aid total 100 parts by weight.

2. The method of claim 1 wherein the binder is water soluble soy protein, vegetable protein, or derivatives thereof.

3. The method of claim 1 wherein the binder is water soluble corn starch, polysaccharides, or derivatives thereof.

4. The method of claim 1 wherein the binder is a water soluble cellulosic derivative.

5. The method of claim 1 additionally containing a chemical dispersing aid for the particulate microwave susceptor material.

6. The method of claim 5 wherein the chemical dispersing aid is polyoxyethylene (20) glycerin monostearate, polyoxyethylene (20) sorbitan monolaurate (Polysorbate 20), polyoxyethylene (20) sorbitan monostearate (Polysorbate 60), or polyoxyethylene (20) sorbitan monooleate (Polysorbate 80).

7. The method of claim 1 wherein the microwave susceptor material is carbon, carbon black, or graphite.

8. The method of claim 1 wherein the natural polymer binder is present in an amount of 9 to 13 parts by weight and the microwave susceptor material is present in an amount of 9 to 13 parts by weight.

9. The method of claim 1 wherein the ink has greater than 20 percent by weight solids.

10. A process for making a liquid coating composition for forming a microwaveable coating, comprising;
a) combining, to form a mixture:
(i) particulate microwave susceptor material,
(ii) water, and
(iii) optionally, a chemical dispersing aid for the microwave susceptor material,
b) milling the mixture to separate any aggregated particles of microwave susceptor material and to disperse the microwave susceptor material in the water, to form a mixture of substantially non-aggregated microwave susceptor material in a solvent, and
c) contacting the mixture of substantially non-aggregated microwave susceptor material in water with a natural polymer binder to form a liquid suitable for printing an article for the purpose of converting a portion of microwave energy to heat.

11. The process for making a liquid coating composition of claim 10 wherein the mixture also contains a chemical defoaming aid.

12. The process of claim 10 wherein the liquid suitable for printing an article has greater than 20 percent by weight solids.
